(19) United States
(12) Patent Application Publication
(10) Pub. No.: US 2009/0057298 A1
(43) Pub. Date: Mar. 5, 2009

(54) Device for Inductive Energy Transmission with Resonant Circuit

(75) Inventor: Thomas Komma, Ottobrunn (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgeräte GmbH, München (DE)

(21) Appl. No.: 12/226,376

(22) PCT Filed: Mar. 22, 2007
(86) PCT No.: PCT/EP2007/052736

§ 371 Date: Oct. 16, 2008

(30) Foreign Application Priority Data
Apr. 18, 2006 (DE) 10 2006 017 802.5

(51) Int. Cl. H05B 6/12; H02J 17/00

(52) U.S. Cl. 219/624; 307/104

(57) ABSTRACT

An energy transmission unit is provide that includes a primary unit having a transmission means for the wireless transmission of energy to a secondary unit via a transmission oscillation and an oscillation generation unit for generating the transmission oscillation. In order to achieve a high degree of flexibility in use, the oscillation generation unit has a decoupling device that is provided for the purpose of decoupling at least one harmonic associated with the transmission oscillation.

The invention is based on an energy transmission unit as claimed in the preamble of claim 1. There is a known energy transmission unit with a primary side which is provided for inductive transmission of energy to a secondary side which can isolated from the primary side. To this end the energy transmission unit has a primary coil which is supplied with an alternating current. To create the alternating current the energy transmission unit is also provided with an inverter. During the creation of the alternating current, as well as a basic resonance, further harmonics are created which are likewise transmitted via the alternating field.

The object of the invention is especially to further develop the generic energy transmission unit, and to do so particularly in respect of high flexibility in its application.

The object is achieved in accordance with the invention by the features of claim 1, while advantageous embodiments and developments of the invention can be taken from the subclaims.

The invention is based on an energy transmission unit comprising a primary unit with a transmission means for wireless transmission of an energy to a secondary unit by means of a transmission oscillation and an oscillation generation unit for creating the transmission oscillation.

It is proposed that the oscillation generation unit feature a decoupling means which is intended for decoupling at least one harmonic associated with the transmission oscillation. This allows a high level of flexibility in the use of the energy transmission unit to be achieved. If for example safety standards such as EMC standards are to be complied with during an application, the decoupling means allows a wide frequency range to be utilized for the application. The transmission means preferably has a transmission area. In this case the secondary unit can be arranged to interact with the primary unit in the transmission area. In addition the secondary unit is able to be advantageously isolated from the transmission area. The energy transmission unit can be used for heating up a secondary unit for example. In this case the secondary unit can be embodied as cookware. As an alternative or in addition the energy transmission unit can serve to supply electrical energy to a secondary unit which is embodied as an electrical load, e.g. as an electrical device. In addition the secondary unit can be embodied as a power supply unit which itself serves to supply power to an electrical load and obtains an electrical voltage from a transmission of the primary unit. Furthermore the energy transmission unit can advantageously be mounted below a surface, e.g. in a worktop, in a cooktop, below a working surface in a mechanism etc. In such cases the secondary unit can be arranged to interact with the primary unit on the surface. A “harmonic” which is associated with the transmission oscillation can especially be understood as an oscillation having a frequency which is greater than the frequency of the transmission oscillation. In particular the harmonic can be a harmonic of the transmission oscillation. A “transmission area” of the transmission means can be understood as an area of the energy transmission driven by the transmission means. In particular it can be understood as an area within which the secondary unit can receive preferably at least 70%, advantageously at least 90% and especially advantageously at least 95% of the energy made available by the transmission means. A “decoupling means” for decoupling an oscillation can especially be a means for attenuating the oscillation and/or for coupling out the oscillation. Furthermore a “decoupling means” for decoupling an oscillation can be understood as a means which is provided for an at least part removal of the oscillation from a frequency spectrum.

Advantageously the transmission means is provided for inductive transmission of the energy. This particularly allows conventional, cost-effective transmission means to be employed. The transmission means is preferably embodied as a coil in such cases. For example the energy transmission unit is embodied as an induction heating facility. This can be integrated into an induction heating device or embodied itself as an induction heating device. In such cases the secondary unit is preferably embodied as cookware, arranged for heating up food in a transmission area of the transmission means. Cookware of different materials can also be used flexibly for an application with the induction heating device. To this end the induction heating device can feature a first heating mode which is intended for heating up cookware made of a ferromagnetic material. In this case a transmission oscillation between for example 25 kHz and 50 kHz can be created through the oscillation generation unit. The induction heating device can also have at least one second heating mode which is suitable for heating up a cooking utensil made of an a magnetic material, such as aluminum for example. In this case, preferably to achieve short heating-up times, a transmission oscillation with a higher frequency can be generated. The decoupling means enables a frequency range up to a frequency limit which is predetermined by the safely standard to be utilized for the creation of the transmission oscillation. For example, with reference to EMC standard EN55022 a transmission oscillation for transmission of energy up to a frequency of 150 kHz can be generated.

As an alternative or in addition the energy transmission unit can be used for induction of a voltage in the secondary unit. In such cases this voltage can be used as an operating voltage for operation of an electrical load connected to the secondary unit. In this context the secondary unit preferably features an inductive receive element, such as a secondary coil, in which the voltage can be induced. In such cases the transmission means of the primary unit and the receive element of the secondary unit advantageously form a transformer. Preferably the decoupling means features an inductor. This easily allows an advantageous smoothing of a current which oscillates with the transmission oscillation to be achieved. This is especially advantageous if the current oscillating with the transmission oscillation is created by a cycle of switching processes. If the transmission means is provided as a transmission inductance for inductive transmission of the energy, the inductance of the decoupling means advantageously has a value which is smaller than the value of the transmission inductance.

In a preferred embodiment of the invention it is proposed that the decoupling means features a resonant circuit. This allows an effective decoupling of high frequencies to be achieved using fewer components, such as by short-circuiting or blocking these high frequencies for example. The term “high frequency” should be understood in this context especially as a frequency which is greater than a resonant frequency of the resonant circuit. Especially advantageously this frequency can be at least a multiple, e.g. four times, the resonant frequency.

In this context it is proposed that the resonant circuit be embodied as a series oscillating circuit. This allows an especially simple, cost-effective embodiment of the decoupling means to be achieved.

It is also proposed that the resonant circuit feature at least one decoupling point to which the transmission means is connected. This allows an especially effective decoupling of harmonics of the transmission oscillation for energy transmission to be achieved with a simple circuit design. A “decoupling point” of the resonant circuit in this context should especially be understood as a point of the resonant circuit at which a branch can be connected, with high frequencies being decoupled in this branch. Advantageously the resonant circuit can feature at least two decoupling points which delimit a section of the resonant circuit between which a branch can be connected in parallel to the section. Preferably the transmission means is arranged in the branch. Expediently the section represents a short circuit for the high frequencies, with these high frequencies able to be decoupled in the parallel branch. In an advantageous embodiment of the invention it is proposed that the resonant circuit features a capacitor and that the decoupling point is embodied as a capacitor terminal. A decoupling of high frequencies can be achieved especially simply and effectively in this way since the capacitor represents an especially small reactance for these high frequencies. In particular the capacitor can represent a short circuit for the high frequencies.

Preferably the oscillation generation unit features a bridge circuit with a bridge topology. This enables an existing oscillation generation unit with a conventional circuit topology to be used. The bridge circuit can feature a half-bridge topology, with only one bridge side comprising switching means for creating an alternating current. Alternatively the bridge circuit can have a full-bridge topology, with switching means being arranged on two sides of the bridge. The switching means preferably feature switching transistors, which are embodied for example as FETs (Field Effect Transistors) or as IGBTs (Insulated Gate Bipolar Transistors).

In this context the decoupling means can be manufactured with low outlay by adapting an existing topology of the oscillation generation unit, if the decoupling means is connected into a branch of the bridge circuit.

It is further proposed that the oscillation generation unit be embodied as a current converter. This enables an existing cost-effective oscillation generation unit to be employed. For example the current converter is embodied as an inverter.

Further advantages emerge from the description of the drawing given below. The drawing shows exemplary embodiments of the invention. The drawing, the description and the claims contain numerous features in combination. The person skilled in the art would expediently also consider the features individually and combine them into further sensible combinations.

The figures are as follows:

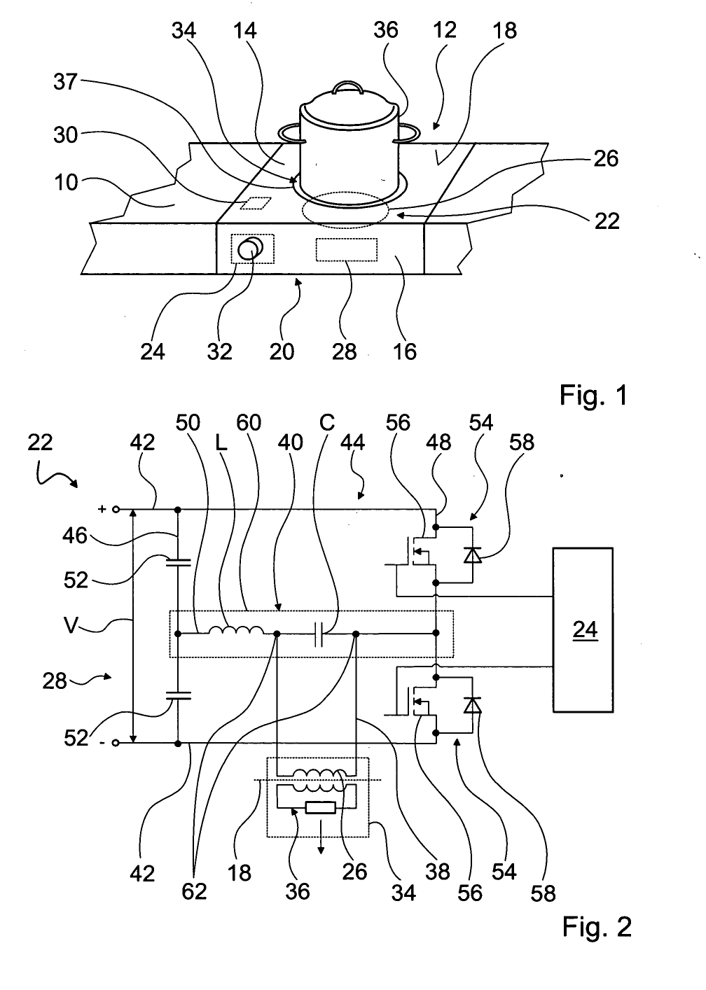

FIG. 1 an induction heating device with an energy transmission unit, which has a transmission means, and a pot,

FIG. 2 an oscillation generation unit of the energy transmission unit with the transmission means and a decoupling means,

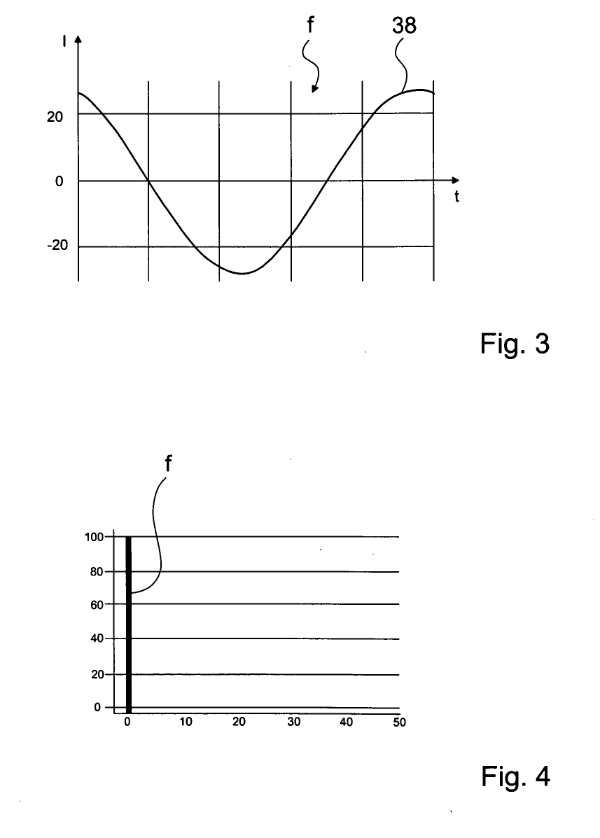

FIG. 3 the timing curve of an alternating current flowing through the transmission means and

FIG. 4 a frequency spectrum of the alternating current.

FIG. 1 shows a kitchen work surface 10 with a cooktop 12, into which an induction heating unit 14 is integrated. The induction heating unit 14 features a housing 16 with an upper plate 18 and an energy transmission unit 20, which comprises a primary unit 22 with a control unit 24, a transmission means 26, an oscillation generation unit 28, a detection unit 30 and a control element 32. The control element 32 is arranged on the front side of the housing 16 and is used for switching the induction heating device 14 on and off as well as for regulating a heating temperature. The transmission element 26 is embodied as a coil and is intended for induction within a transmission area 34 depicted on the upper plate 18 of energy to a secondary unit 36 arranged in the transmission area 34. In this exemplary embodiment the secondary unit 36 is embodied as a pot. The transmission area 34 is indicated by a line 37 on the upper plate 18. During operation an alternating current 38 (FIG. 2) is injected into the transmission means 26 by the oscillation generation unit 28, which is embodied as an inverter. The alternating current 38 exhibits a transmission oscillation f (FIG. 3), so that a magnetic alternating field with the transmission oscillation f is created by the transmission means 26. The alternating current 38 is created by switching processes in the oscillation generation unit 28, with said processes being controlled by the control unit 24. The alternating field creates eddy currents by magnetic induction in the floor of the secondary unit 36 embodied as a pot. The floor is heated up by said currents, which heats up the food arranged in the pot (not shown).

It is initially assumed that the secondary unit 36 embodied as a pot consists of a ferromagnetic material. To heat up the food in the pot a first heat mode of the energy transmission unit 20 is switched on, in which the alternating current 38 is created by the oscillation generation unit 28 with a transmission oscillation f=25 kHz. At this frequency the penetration depth of the alternating field created by the transmission means 26 into the ferromagnetic material corresponds to the thickness of the floor of the secondary unit 36, so that an optimum heating-up of the food and especially a short cooking time can be achieved. It is now assumed that the pot is made from an a magnetic material, e.g. aluminum. An operation of the energy transmission unit 20 with the transmission oscillation f of the first heat mode would lead to an inconveniently long cooking time, since the penetration depth of the alternating field created by the transmission means 26 into aluminum for this frequency is greater than the thickness of the floor of the secondary unit 36. In this case only a part of the transmitted energy would be converted into heat in the floor. The placement of the secondary unit 36 made of aluminum is detected by the detection unit 30 which transmits a detection signal to the control unit 24. On the basis of this detection signal the control unit 24 switches on a second heat mode, in which the alternating current 38 is created with a transmission oscillation f=100 kHz. Further, especially higher frequencies, up to a limits of 150 kHz are conceivable. This limit is prescribed by the safety standard EN55022. This standard can be adhered to during operation in the second heat mode especially by the energy transmission unit 20 being provided with a decoupling means 40 (FIG. 2) which is intended to decouple the harmonic component of the transmission oscillation f.

FIG. 2 shows a schematic diagram of an internal circuit of the primary unit 22. The transmission means 26 embodied as a coil, the oscillation generation unit 28 and the control unit 24 for controlling the oscillation generation unit 28 can be seen in the figure. The secondary unit 36 is also depicted schematically. An ohmic resistor represents the ohmic resistance of the floor of the secondary unit 36 while an inductor represents the inductance of this floor. The secondary unit 36 is can be isolated from the transmission area 34 of the transmission means 26, an operation which is indicated by an arrow. The upper plate 18 is shown by a dashed line. The transmission area 34 of the transmission means 26 is likewise shown by a dashed line.

The oscillation generation unit 28 is embodied as an inverter. It features two lines 42, between which a DC voltage V is applied. To this end the lines 42 are connected to a rectifier (not shown), which rectifies an alternating current of an AC supply into the DC voltage V. Between the lines 42 the oscillation generation unit 28 has a bridge circuit 44. This bridge circuit 44 has two bridge sides 46, 48 which are connected by a bridge branch 50. The first bridge side 46 features two capacitors 52 which serve to stabilize the DC voltage V. The second bridge side 48 comprises two switching means 54, which feature a transistor 56 and a free-wheeling diode 58 in each case. The free-wheeling diodes 58 are each connected in parallel to one of the transistors 56. The transistors 56 are embodied as FETs (Field Effect Transistors) in each case. As an alternative IGBTs (Insulated Gate Bipolar Transistors) can be used. A version of the bridge circuit 44 with a full bridge topology, in which the bridge side 46 is also provided with switching means 54, is conceivable. The transmission oscillation f is created by switching processes of the switching element 54 which are controlled by means of the control unit 24. The functional principle of an inverter for creating an alternating current is known and will not be further explained within the context of this description. Furthermore the oscillation generation unit 28 features the decoupling means 40. This is connected into the bridge branch 50. The decoupling means 40 is embodied in the form of a series oscillating circuit with a capacitor C and an inductor L as resonant circuit 60 (highlighted by a dashed outline in the figure). In this case the inductor L has a value which is smaller than the inductance of the transmission means 26. Advantageously the inductor L has a value which is for example 10 times smaller than the inductance of the transmission means 26. The resonant circuit 60 has a resonant frequency f_{R} which is given by f_{R}=1/(2π\sqrt{LC}. For example this resonant frequency f_{R} has a value of 50 kHz. If we imagine that frequency injected into the resonant circuit 60 rises above the resonant frequency f_{R}, the inductive resistance of the inductor L increases for this frequency while the capacitive resistance of the capacitor C falls. For high frequencies, which preferably represent at least a multiple of the resonant frequency f_{R}, the capacitor C can be considered as a short circuit for these high frequencies. Consequently the terminals of the capacitor C form two decoupling points 62, between which a current signal can be obtained, in which these high frequencies are decoupled. If the resonant circuit 60 is supplied during operation of the second heating mode with a transmission oscillation f of for example 150 kHz, which represents the limit prescribed by the EMC standard, the harmonics of this transmission oscillation f at 300 kHz, 375 kHz etc. will be decoupled in a functional component connected to the decoupling points 62. The transmission means 26 is connected to the decoupling points 62 of the resonant circuit 60. As a consequence an alternating current 38 flows through the transmission means 26 which has the transmission oscillation f and in which the harmonics of the transmission oscillation f are decoupled. This can be taken from FIGS. 3 and 4.

FIG. 3 shows the timing curve of the alternating current 38 flowing through the transmission means 26 as a function of the time t over a period of time. The current amplitude I of the alternating current 38 in Amperes is plotted on the y-axis. As can be seen from the Figure, the alternating current 38 has a sine-wave form. The alternating current 38 was detected by connecting a current measuring device in series with the transmission means 26 (not shown). A frequency spectrum can be seen in FIG. 4 which is produced by a Fourier analysis of the alternating current 38. Channels are plotted on the x-axis, with one channel corresponding to one harmonic of the transmission oscillation f. A proportion in percent of the overall current amplitude I is plotted on the y-axis. As can be seen in the figure, the alternating current 38 only has one component which corresponds to the transmission oscillation f. The harmonic component of the alternating current 38 is decoupled by the decoupling means 40.

### REFERENCE SYMBOLS

10 Kitchen worktop
12 Cooktop
14 Induction heating device
16 Housing
18 Plate
20 Energy transmission unit
22 Primary unit
24 Control unit
26 Transmission means
28 Oscillation generation unit-
30 Detection unit
32 Control element
34 Transmission area
36 Secondary unit
37 Line
38 Alternating current
40 Decoupling means
42 Line
44 Bridge circuit
46 Bridge side
48 Bridge side
50 Bridge branch
52 Capacitor
58 Free-wheeling diode
60 Resonant circuit
62 Decoupling point
V DC voltage
l Current amplitude
f Transmission oscillation
f_{R} Resonant frequency
t Time
C Capacitor
L inductor 54 Switching means 26 Transistor

1-11. (canceled)

12. An energy transmission unit comprising
a primary unit with a transmission means for wireless transmission of an energy to a secondary unit by means of a transmission oscillation; and
an oscillation generation unit for creating the transmission oscillation, the oscillation generation unit including a decoupling means operable to decouple at least one harmonic associated with a transmission oscillation.

13. The energy transmission unit as claimed in claim 12, wherein the transmission means is intended for inductive transmission of the energy.

14. The energy transmission unit as claimed in claim 12, wherein the decoupling means includes an inductor.

15. The energy transmission unit as claimed in claim 12, wherein the decoupling means includes a resonant circuit.

16. The energy transmission unit as claimed in claim 15, wherein the resonant circuit is embodied as a series oscillating circuit.

17. The energy transmission unit as claimed in claim 15, wherein the resonant circuit includes at least one decoupling point to which the transmission means is connected.

18. The energy transmission unit as claimed in claim 17, wherein the resonant circuit features a capacitor and the decoupling point is embodied as a capacitor terminal

19. The energy transmission unit as claimed in claim 12, wherein the oscillation generation unit includes a bridge circuit with a bridge topology.

20. The energy transmission unit as claimed in claim 19, wherein the decoupling means is connected in a bridge branch of the bridge circuit.

21. The energy transmission unit as claimed in claim 12, wherein the oscillation generation unit is embodied as a current converter.

22. An induction heating device comprising:
an inductive heat source; and
an energy transmission unit energy transmission unit including:
(a) a primary unit with a transmission means for wireless transmission of an energy to a secondary unit by means of a transmission oscillation, and
(b) an oscillation generation unit for creating the transmission oscillation, the oscillation generation unit including a decoupling means operable to decouple at least one harmonic associated with a transmission oscillation.
